(19) United States
(12) Patent Application Publication
(10) Pub. No.: US 2015/0049702 A1
(43) Pub. Date: Feb. 19, 2015

(54) CHANNEL STATE INFORMATION FEEDBACKS FOR COORDINATED MULTIPOINT TRANSMISSIONS

(71) Applicants: Fang-Chen Cheng, Randolph, NJ (US); Hongwei Yang, Shanghai (CN)

(72) Inventors: Fang-Chen Cheng, Randolph, NJ (US); Hongwei Yang, Shanghai (CN)

(73) Assignee: ALCATEL LUCENT, Boulogne Billancourt (FR)

(21) Appl. No.: 14/387,095

(22) PCT Filed: Mar. 22, 2012
(86) PCT No.: PCT/CN2012/072828

§ 371 Date: Sep. 22, 2014

(51) Int. Cl. H04B 7/02; H04L 5/00; H04B 7/06

(52) U.S. Cl. CPC H04B 7/024; H04B 7/0626; H04L 5/0035; H04L 5/0053
USPC 370/329

(57) ABSTRACT

A method and a User Equipment (UE) for used in a Coordinated Multiple (CoMP) transmission are disclosed. The method for example comprises: acquiring a Channel State Information (CSI) feedback for each of at least one non-zero-power Channel State Information Reference Signal (CSI-RS) resource respectively, and providing, to a network side, at least one CSI feedback so as to facilitate a coordination of Downlink (DL) transmissions in the DL CoMP transmission at the network side. By doing so, a new Channel State Information (CSI) feedback reporting mode is introduced, so as to provide to a network side a plurality of CSI feedbacks based on which a better coordination of DL transmissions in the CoMP transmission can be achieved.

### FIELD OF THE INVENTION

Embodiments of the present invention generally relates to communication systems, and more particularly to a method, a user equipment, and a computer-readable storage medium for reporting Channel State Information (CSI) feedbacks to a network side, for example, to a Transmission Point (TP).

### BACKGROUND OF THE INVENTION

This section introduces aspects that may help facilitate a better understanding of the invention(s). Accordingly, the statements of this section are to be read in this light and are not to be understood as admissions about what is in the prior art or what is not in the prior art.

The abbreviations and terms appearing in the description and drawings are defined as below.
3GPP Third Generation Partnership Project
CoMP Coordinated Multipoint
eNB E-UTRAN NodeB, Base Station in E-UTRAN
CSI-RS Channel State Information Reference Signal
DL Downlink
E-UTRAN Evolved UTRAN
MIMO Multiple Input Multiple Output
PUSCH Physical Uplink Shared Channel
PDSCH Physical Downlink Shared Channel
TP Transmission Point
JT Joint Transmission
DPS Dynamic Point Selection
CQI Channel Quality Indicator
PMI Pre-coding Matrix Indicator
PUCCH Physical Uplink Control Channel
TDM Time Division Multiplexing
FDM Frequency Division Multiplexing
CDM Code Division Multiplexing
LTE-A Long Term Evolution-Advanced
UE User Equipment

When certain neighbouring TPs are serving for their own users, co-channel interferences may be raised to those users served by other TPs. To cope with such a situation, a mechanism called CoMP is introduced by the 3GPP, which requires co-operations of DL transmission between the TPs (for example, eNBs). At present, the CoMP includes three schemes, Joint Transmission (JT), Dynamic Point Selection (DPS), and coordinated scheduling and coordinated beam-forming (CS/CB). With the JT as an example, there may be at least two TPs serving for one UE through respective MIMO channels to the UE at the same time.

A working assumption was made in 3GPP to allow multiple non-zero-power CSI-RS resources to be configured to a Release-11 UE by dedicated signalling at least for CSI feedback. The non-zero-power CSI-RS resources are used to facilitate a UE in acquiring a CSI feedback.

### SUMMARY OF THE INVENTION

The inventors found that, after the CoMP scheme is introduced, more than one CSI-RS resources can be configured to a UE; and a network side that performs the CoMP scheme needs UEs to provide CSI feedbacks so as to enhance co-operations between TPs in a cooperating set of the CoMP scheme and thereby improve transmission qualities. However, there is no solution on how to provide a plurality of CSI feedbacks to the network side.

To better address one or more of the above concerns, in a first aspect of the invention, a method is provided. The method for example comprises: acquiring a Channel State Information (CSI) feedback for each of at least one non-zero-power Channel State Information Reference Signal (CSI-RS) resource respectively, and providing, to a network side, the CSI feedback so as to facilitate a coordination of Downlink (DL) transmissions in the DL CoMP transmission at the network side.

In a second aspect of the invention, a UE is provided. The UE for example comprises: a processor, configured to acquire a Channel State Information (CSI) feedback for each of at least one non-zero-power Channel State Information Reference Signal (CSI-RS) resource respectively; and a transmitter, configured to provide, to a network side, the CSI feedback so as to facilitate a coordination of Downlink (DL) transmissions in the DL CoMP transmission at the network side.

In a third aspect of the invention, a computer-readable storage medium is provided. The storage medium carries one or more sequences of one or more instructions which, when executed by one or more processors of UE, cause the UE carrying the steps of the method as stated in the first aspect of the invention.

Particular embodiments of the subject matter described in this specification can be implemented so as to realize one or more of the following advantages.

With particular embodiments of the techniques described in this specification, the network side can be notified of a plurality of CSI feedbacks with each one associated with one CSI-RS resource. As a result, the CoMP scheme can use the CSI feedbacks to coordinate DL transmissions, which improve system performance.

Other features and advantages of the embodiments of the present invention will also be understood from the following description of specific embodiments when read in conjunction with the accompanying drawings, which illustrate, by way of example, the principles of embodiments of the present invention.

### BRIEF DESCRIPTION OF THE DRAWINGS

The above and other aspects, features, and benefits of various embodiments of the invention will become more fully apparent, by way of example, from the following detailed description and the accompanying drawings, in which:

FIG. 1 illustrates an exemplary method for used in a CoMP transmission according to an embodiment of the present invention;

FIG. 2 illustrates exemplary aperiodic CSI feedback modes according to an embodiment of the present invention;

FIG. 3 illustrates exemplary periodic CSI feedback modes according to an embodiment of the present invention; and

FIG. 4 illustrates an exemplary block diagram of a UE that may be configured to practice the exemplary embodiments of the present invention.

Like reference numbers and designations in the various drawings indicate like elements. What is more, the number and naming of elements shown in the figures is only for illustration, not for limitation.

### DETAILED DESCRIPTION OF EMBODIMENTS

Hereinafter, the principle and spirit of the present invention will be described with reference to the illustrative embodiments. It should be understood, all these embodiments are given merely for the skilled in the art to better understand and further practice the present invention, but not for limiting the scope of the present invention. For example, features illustrated or described as part of one embodiment may be used with another embodiment to yield still a further embodiment. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The disclosed subject matter will now be described with reference to the attached figures. Various structures, systems and devices are schematically depicted in the drawings for purposes of explanation only and so as to not obscure the description with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

As previously mentioned, a solution is highly desired for reporting a plurality of CSI feedbacks to the network side. In this regard, the invention provides a method, a UE, and a computer-readable storage medium for used in a CoMP transmission, which acquire and provide, to the network side, the CSI feedback for each of at least one non-zero power CSI-RS resource respectively. According to the solution, a CSI feedback includes at least one PMI associated with one CSI-RS resource and at least one CQI derived based on a specified CoMP transmission scheme. It is obvious that such a solution is novel, which fills the gap in the art. With the CSI feedbacks, the CoMP scheme can implement much better co-operations among TPs in a cooperating set.

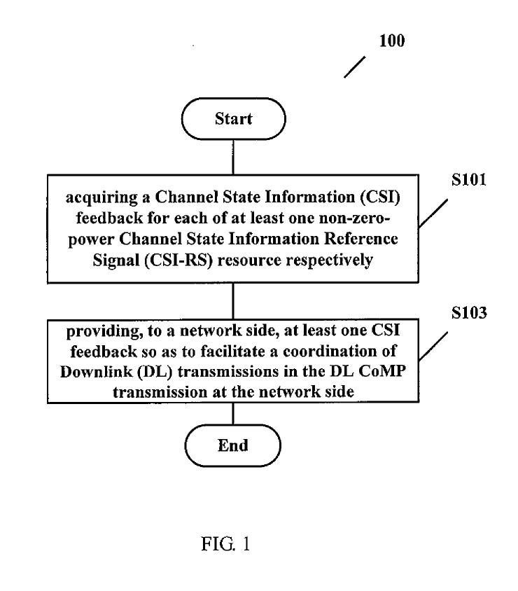

Next, the method for used in a CoMP transmission is described with reference to FIG. 1.

As illustrated in FIG. 1, a method 100 for example includes acquiring a Channel State Information (CSI) feedback for each of at least one non-zero-power Channel State Information Reference Signal (CSI-RS) resource respectively, step S101.

The skilled person can appreciate that each non-zero-power CSI-RS resource can be utilized by a UE to acquire a CSI feedback on a transmission channel where the CSI-RS resource is transmitted. After the CoMP scheme is introduced, at least one non-zero-power CSI-RS resource can be sent to a UE. According to the embodiments of the invention, one CSI feedback relates to one CSI-RS resource.

Next, the method 100 for example may further include providing, to a network side, at least one CSI feedback so as to facilitate a coordination of Downlink (DL) transmissions in the DL CoMP transmission at the network side, step S103.

As mentioned above, after acquiring a plurality of CSI feedbacks, the CoMP transmission scheme can improve co-operations among TPs in a cooperating set.

According to some embodiments of the invention, the CSI feedback can include at least one Channel Quality Indicator (CQI) and at least one Pre-coding Matrix Indicator (PMI) associated with the each of at least one CSI-RS resource. Put another way, for each of at least one CSI-RS resource, there can be one or more CQIs and one or more PMIs.

According to some embodiments of the invention, step S101 can include deriving the at least one CQI based on a specified CoMP transmission scheme, which will be discussed in detail as below.

According to some embodiments of the invention, the specified CoMP transmission scheme involved in the embodiments of invention includes Joint Transmission (JT) scheme or Dynamic Point Selection (DPS) scheme. As known in the art, a UE can be served by more than one TPs under the JT scheme, and a UE can be served by only one TP at a time under the DPS scheme.

According to some embodiments of the invention, in the case of JT scheme, step S101 for example can include deriving the at least one CQI based on all Multiple Input Multiple Output (MIMO) channels of all of at least one non-zero-power CSI-RS resource. It is easy to understand that there are more than one transmission MIMO channels to a UE in the case of JT scheme at a time, and thus at least one aggregated CQI is derived based on all channels. As discussed as below, the at least one aggregated CQI may include higher layer-configured sub-band CQIs, UE-selected sub-band CQIs or one wideband CQI, which are derived based on the all MIMO channels.

According to some embodiments of the invention, in the case of DPS scheme, step S101 for example can include deriving the at least one CQI for each of at least one non-zero-power CSI-RS resource in the case of DPS scheme. It is also easy to understand that there is only one transmission MIMO channel to a UE in the case of DPS scheme at a time, and thus one CQI is related to one non-zero-power CSI-RS resource, i.e., one MIMO channel, instead of based on aggregated MIMO channels. As discussed as below, the at least one CQI may include higher layer-configured sub-band CQIs, UE-selected sub-band CQIs or one wideband CQI, each of which is derived for each of at least one non-zero-power CSI-RS resource in the case of DPS scheme.

It should be noted that any exiting, under-developing, or to-be-developed methods can be used to derive the CQIs, and therefore any specific deriving method can not be used to limit the scope of the invention.

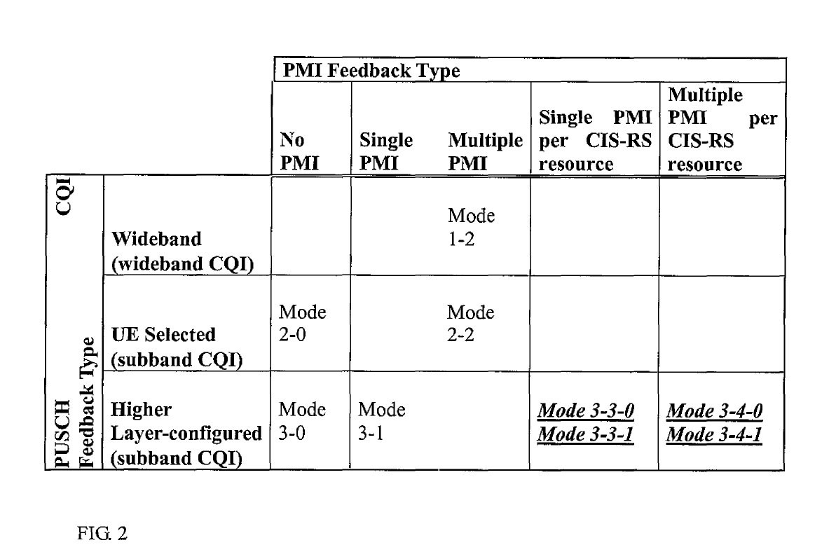

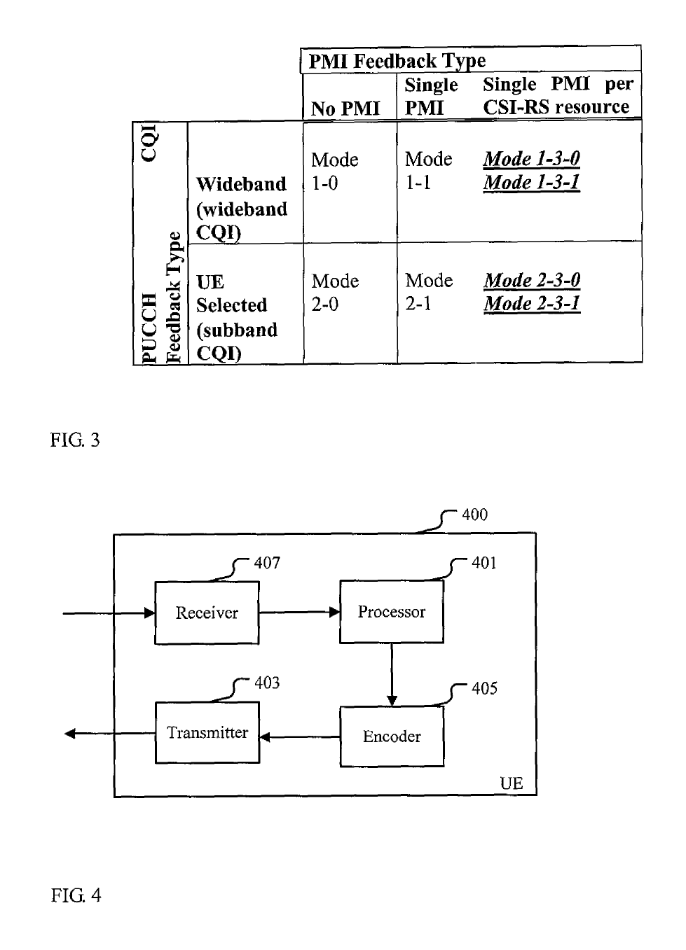

After explaining the embodiments of the invention in general aspects, next, four specific reporting modes for CSI feedbacks, i.e., two aperiodic reporting modes and two periodic reporting modes are illustrated with reference to FIGS. 2 and 3 respectively.

FIG. 2 illustrates two exemplary aperiodic CST feedback modes according to an embodiment of the present invention.

It should be noted that, the inventor found that most companies showed CoMP performance gain over single cell MIMO with feedback assumptions of sub-band CQI and wideband/sub-band PMI with frequency selective scheduling, and the coordination of PDSCH transmissions from single or multiple transmission points would be most likely at the sub-band level to get the gain from coordination of resource allocation and channel frequency selectivity. Thus, new CSI feedback modes should include sub-band CQI with one wideband PMI or multiple sub-band PMIs. Moreover, multiple CST feedbacks with UE-selected sub-bands are not appropriate since an eNB needs to perform scheduling and spatial coordination. The UE-selected sub-band CQI might not be feasible since the frequency selective scheduling needs to coordinate scheduling for all UEs in a cluster of TPs. The increasing number of UEs in the scheduling coordination would decrease the probability of a full match between the sub-band scheduled and the sub-band selected by the UE to feed back the CQI.

Therefore, the inventor proposes to introduce two aperiodic CSI feedback modes, e.g. modes 3-3 (including mode 3-3-0 and mode 3-3-1) and 3-4 (including mode 3-4-0 and mode 3-4-1) as shown in FIG. 2, which are emphasized in bold italic font. It is easy for the skilled person to understand that other modes as shown in FIG. 2 are well-known in the art. The meaning of the one mode, e.g. mode 3-3, comprises that the CSI feedback includes higher layer-configured CQIs and single PMI (i.e., a wideband PMI) for each CSI-RS resource, as illustrated by the titles of its corresponding row (x dimension) and column (y dimension). Likewise, the meaning of the other mode, e.g. mode 3-4, comprises that the CSI feedback includes higher-configured CQIs and multiple PMIs (i.e., at least one sub-band PMI) for each CIS-RS resource.

Put another way, according to at least two PUSCH CSI reporting modes, e.g. modes 3-3 and 3-4, of the embodiments of the invention, at least one CQI composed the CSI feedback includes higher layer-configured sub-band CQIs, and the at least one PMI associated with the each of at least one CSI-RS resource includes one wide-band PMI or at least one sub-band PMI associated with the each of at least one CSI-RS resource.

Further, to differentiate the CSI feedback modes for different CoMP transmission schemes, names “Mode x-y-z” are introduced, wherein the “z” dimension configures whether the CQI values are per non-zero-power CSI-RS resource (for DPS scheme) or aggregated across all non-zero-power CSI-RS resources (for JT scheme). As shown in FIG. 2, mode 3-3-0 is suitable for the DPS scheme, as stated above, one sub-band CQI value for each set of sub-bands (for example, S sub-bands) is derived for each configured non-zero power CSI-RS resource; and mode 3-3-1 is suitable for the JT scheme, as stated above, a single sub-band CQI is derived based on all aggregated MIMO channels observed from the configured non-zero power CSI-RS resources for each set S sub-bands.

According to some embodiments of the invention, the reported CQI values are reported on rank 1.

Moreover, mode 3-4-0 is suitable for the DPS scheme, as stated above, one sub-band CQI value for each set of sub-bands (for example, S sub-bands) is derived for each configured non-zero power CSI-RS resource; and mode 3-4-1 is suitable for the IT scheme, as stated above, a single sub-band CQI is derived based on all aggregated MIMO channels observed from the configured non-zero power CSI-RS resources for each set S sub-bands. It should be noted that the PMI and CQI values are calculated conditioned on the reported RI (Rank Indication).

It should be noted that any exiting, under-developing, or to-be-developed methods can be used to derive the PMIs, and therefore any specific deriving method can not be used to limit the scope of the invention.

According to some embodiments of the invention, the at least one CQI further includes a wide-band CQI, and, therefore the higher layer-configured sub-band CQIs, when being transmitted to the network side, are represented by values obtained through encoding respective sub-band CQI of the higher layer-configured sub-band CQIs differentially with the wide-band CQI. By doing so, the data to be transmitted on channels can be reduced, whereby the system resources can be saved. It should be noted that the wide-band CQI can also be derived based on the specified CoMP transmission scheme. That is, for the DPS scheme, a wideband CQI is derived for each configured non-zero power CSI-RS resource (related to modes 3-3-0 and 3-4-0); and for the JT scheme, a single wideband CQI is derived based on all aggregated MIMO channels observed from the configured non-zero power CSI-RS resources(related to modes 3-3-1 and 3-4-1).

According to some embodiments of the invention, Step S103 of FIG. 1 for example can include transmitting the wide-band CQI, the higher layer-configured sub-band CQIs and the PMI associated with the each of at least one CSI-RS resource on a Physical Uplink Shared Channel (PUSCH), in response to receiving a trigger from at least one Transmission Point involved in the CoMP transmission.

According to some embodiments of the invention, the coordinated scheduling and coordinated beamforming could use existing aperiodic CSI feedback mode, e.g., PUSCH CSI report mode 3-1.

According to some embodiments of the invention, for coherent joint transmission, inter-point phase feedback on all sub-bands are configurable by higher layer signaling.

It should be noted that aperiodic CSI feedback would be good candidates for multiple CSI feedbacks, since PUSCH would have sufficient capacity to carry all CSI feedbacks in the same time.

FIG. 3 illustrates two exemplary periodic CSI feedback modes according to an embodiment of the present invention. As shown in FIG. 3, two periodic CSI feedback modes, e.g. modes 1-3 (including modes 1-3-0 and 1-3-1) and 2-3 (including modes 2-3-0 and 2-3-1), according to embodiments of the invention are emphasized in bold italic font. It is easy for the skilled person to understand that other modes as shown in FIG. 3 are well-known in the art. The meaning of one mode, e.g. the mode 1-3, comprises that the CSI feedback includes one wideband CQI and a single PMI (i.e., a wideband PMI) for each CSI-RS resource, as illustrated by the titles of its corresponding row (x dimension) and column (y dimension). Likewise, the meaning of the other mode, e.g. mode 2-3, comprises that the CSI feedback includes UE-selected sub-band CQIs and single PMI (i.e., a wideband PMI) for each CSI-RS resource.

Put another way, according to at least two modes, e.g., modes 1-3 and 2-3 of the embodiments of the invention, at least one CQI composed the CSI feedback includes UE-selected sub-band CQIs or one wideband CQI, and the at least one PMI associated with the each of at least one CSI-RS resource includes one wide-band PMI associated with the each of at least one CSI-RS resource.

As stated before, to differentiate the CSI feedback modes for different CoMP transmission schemes, names “Mode x-y-z” are introduced, wherein the “z” dimension configures whether the CQI values are per non-zero-power CSI-RS resource (for DPS scheme) or aggregated across all non-zero-power CSI-RS resources (for JT scheme). As shown in FIG. 3, modes 1-3-0 and 2-3-0 are suitable for the DPS scheme, which are derived for each configured non-zero-power CSI-RS resource; and modes 1-3-1 and 2-3-1 are suitable for the JT scheme, which are derived based on all aggregated MIMO channels observed from the configured non-zero power CSI-RS resources.

It should be noted that any exiting, under-developing, or to-be-developed methods can be used to derive the PMIs, and therefore any specific deriving method can not be used to limit the scope of the invention.

According to some embodiments of the invention, in the case of UE-selected sub-band CQIs, the at least one CQI composed the CSI feedbacks may further include a wide-band CQI, and, therefore the UE-selected sub-band CQIs, when being transmitted to the network side, are represented by values obtained through encoding respective sub-band CQI of the higher layer-configured sub-band CQIs differentially with the wide-band CQI. By doing so, the data to be transmitted on channels can be reduced, whereby the system resources can be saved. The derivation of the wide-band CQI is identical to that of aperiodic CSI feedback modes.

According to some embodiments of the invention, Step S103 of FIG. 1 for example can include transmitting the at least one CQI and the at least one PMI on a plurality of Physical Uplink Control Channel (PUCCH) resources periodically. As the skilled person appreciated, the period is provided by the network to UEs.

According to some embodiments of the invention, the plurality of PUCCH resources are allocated in a Time Division Multiplexing (TDM), a Frequency Division Multiplexing (FDM) or a Code Division Multiplexing (CDM).

Specifically, Multiple PUCCH resources are configured in multiple subframes with same period (TDM) by higher layer—each CSI is transmitted in a subframe.

Multiple PUCCH resources within a subframe (FDM) by higher layer—additional PUCCH format 2/2a/2b resources could be configured in the same time. Each PUCCH resource for one of multiple CSI feedbacks.

Multiple cyclic shift in a PUCCH resource are allocated for multiple CSI feedback (CDM)—Each CSI feedback are configured at one cyclic shift.

According to some embodiments of the invention, periodic CSI feedbacks are carried on PUCCH format 2/2a/2b. Coordinated scheduling and coordinated beamforming could use existing periodic CSI feedback mode, e.g., PUSCH CSI report mode 2-1.

FIG. 4 illustrates an exemplary block diagram of a UE that may be configured to practice the exemplary embodiments of the present invention. As shown in FIG. 4, the UE 400 may include a processor 401, configured to acquire a Channel State Information (CSI) feedback for each of at least one non-zero-power Channel State Information Reference Signal (CSI-RS) resource respectively; and a transmitter 403, configured to provide, to a network side, the CSI feedback so as to facilitate a coordination of Downlink (DL) transmissions in the DL CoMP transmission at the network side.

According to some embodiments of the invention, the CSI feedback comprises at least one Channel Quality Indicator (CQI) and at least one Pre-coding Matrix Indicator (PMI) associated with the each of at least one CSI-RS resource.

According to some embodiments of the invention, the processor 401 is further configured to derive the at least one CQI based on a specified CoMP transmission scheme.

According to some embodiments of the invention, the specified CoMP transmission scheme comprises Joint Transmission (JT) scheme or Dynamic Point Selection (DPS) scheme.

According to some embodiments of the invention, the processor 401 is further configured to derive the at least one CQI based on all Multiple Input Multiple Output (MIMO) channels of all of at least one non-zero-power CSI-RS resource in the case of JT scheme.

According to some embodiments of the invention, the processor 401 is further configured to derive the at least one CQI for each of at least one non-zero-power CSI-RS resource in the case of DPS scheme.

According to some embodiments of the invention, the at least one CQI comprises higher layer-configured sub-band CQIs.

According to some embodiments of the invention, at least one PMI associated with the each of at least one CSI-RS resource comprises one wide-band PMI or at least one sub-band PMI associated with the each of at least one CSI-RS resource.

According to some embodiments of the invention, the at least one CQI further comprises a wide-band CQI, and, wherein the higher layer-configured sub-band CQIs are represented by values obtained through encoding, by an encoder 405 of the UE 400, respective sub-band CQI of the higher layer-configured sub-band CQIs differentially with the wide-band CQI.

According to some embodiments of the invention, the transmitter 403 is further configured to transmit the wide-band CQI, the higher layer-configured sub-band CQIs and the PMI associated with the each of at least one CSI-RS resource on a Physical Uplink Shared Channel (PUSCH), in response to a receiver 407 of the UE 400 receiving a trigger from at least one Transmission Point involved in the CoMP transmission.

According to some embodiments of the invention, at least one CQI comprises UE-selected sub-band CQIs or one wideband CQI.

According to some embodiments of the invention, the at least one PMI associated with the each of at least one CSI-RS resource comprises one wide-band PMI associated with the each of at least one CSI-RS resource.

According to some embodiments of the invention, the transmitter 403 is further configured to transmit the at least one CQI and the at least one PMI on a plurality of Physical Uplink Control Channel (PUCCH) resources periodically.

According to some embodiments of the invention, the plurality of PUCCH resources are allocated in a Time Division Multiplexing (TDM), a Frequency Division Multiplexing (FDM) or a Code Division Multiplexing (CDM).

It should be noted that the above-mentioned functions can be implemented in any component of the UE 400, and the invention is not limited in this regard. Also, UE stands for any computing device that can provide CSI feedbacks. The invention is not limited in this regard.

According to some embodiments of the invention, a computer-readable storage medium carrying one or more sequences of one or more instructions which, when executed by one or more processors 401 of User Equipment (UE) 400, cause the UE 400 carrying the steps of the method as illustrated in the application.

Exemplary embodiments of the present invention have been described above with reference to block diagrams and flowchart illustrations of methods, apparatuses (i.e., systems). It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

The foregoing computer program instructions can be, for example, sub-routines and/or functions. A computer program product in one embodiment of the invention comprises at least one computer readable storage medium, on which the foregoing computer program instructions are stored. The computer readable storage medium can be, for example, an optical compact disk or an electronic memory device like a RAM (random access memory) or a ROM (read only memory).

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It should also be noted that the above described embodiments are given for describing rather than limiting the invention, and it is to be understood that modifications and variations may be resorted to without departing from the spirit and scope of the invention as those skilled in the art readily understand. Such modifications and variations are considered to be within the scope of the invention and the appended claims. The protection scope of the invention is defined by the accompanying claims. In addition, any of the reference numerals in the claims should not be interpreted as a limitation to the claims. Use of the verb “comprise” and its conjugations does not exclude the presence of elements or steps other than those stated in a claim. The indefinite article “a” or “an” preceding an element or step does not exclude the presence of a plurality of such elements or steps.

1. A method for used in a Coordinated Multipoint (CoMP) transmission, comprising:
acquiring a Channel State Information (CSI) feedback for each of at least one non-zero-power Channel State Information Reference Signal (CSI-RS) resource respectively, and
providing, to a network side, at least one CSI feedback so as to facilitate a coordination of Downlink (DL) transmissions in the DL CoMP transmission at the network side.

2. The method of claim 1, wherein the CSI feedback comprises at least one Channel Quality Indicator (CQI) and at least one Pre-coding Matrix Indicator (PMI) associated with the each of at least one CSI-RS resource.

3. The method of claim 2, wherein of acquiring comprises deriving the at least one CQI based on a specified CoMP transmission scheme.

4. The method of claim 3, wherein the specified CoMP transmission scheme comprises Joint Transmission (JT) scheme or Dynamic Point Selection (DPS) scheme.

5. The method of claim 4, wherein of acquiring comprises deriving the at least one CQI based on all Multiple Input Multiple Output (MEVIO) channels of all of at least one non-zero-power CSI-RS resource in the case of JT scheme or deriving the at least one CQI for each of at least one non-zero-power CSI-RS resource in the case of DPS scheme.

6. (canceled)

7. The method of claim 5, wherein the at least one CQI comprises higher layer-configured sub-band CQIs or UE-selected sub-band CQIs or one wideband CQI.

8. The method of claim 7, wherein the at least one PMI associated with the each of at least one CSI-RS resource comprises one wide-band PMI or at least one sub-band PMI associated with the each of at least one CSI-RS resource or wherein the at least one CQI further comprises a wide-band CQI, and, wherein the higher layer-configured sub-band CQIs, when being transmitted to the network side, are represented by values obtained through encoding respective sub-band CQI of the higher layer-configured sub-band CQIs differentially with the wide-band CQI or wherein providing comprises transmitting the wide-band CQI, the higher layer-configured sub-band CQIs and the PMI associated with the each of at least one CSI-RS resource on a Physical Uplink Shared Channel (PUSCH), in response to receiving a trigger from at least one Transmission Point involved in the CoMP transmission.

9. (canceled)

10. (canceled)

11. (canceled)

12. The method of claim 7, wherein the at least one PMI associated with the each of at least one CSI-RS resource comprises one wide-band PMI associated with the each of at least one CSI-RS resource.

13. The method of claim 12, wherein providing comprises transmitting the at least one CQI and the at least one PMI on a plurality of Physical Uplink Control Channel (PUCCH) resources periodically.

14. The method of claim 13, wherein the plurality of PUCCH resources are allocated in a Time Division Multiplexing (TDM), a Frequency Division Multiplexing (FDM) or a Code Division Multiplexing (CDM).

15. User Equipment (UE) for used in a Coordinated Multipoint (CoMP) transmission, comprising:
a processor, configured to acquire a Channel State Information (CSI) feedback for each of at least one non-zero-power Channel State Information Reference Signal (CSI-RS) resource respectively; and
a transmitter, configured to provide, to a network side, at least one CSI feedback so as to facilitate a coordination of Downlink (DL) transmissions in the DL CoMP transmission at the network side.

16. The UE of claim 15, wherein the CSI feedback comprises at least one Channel Quality Indicator (CQI) and at least one Pre-coding Matrix Indicator (PMI) associated with the each of at least one CSI-RS resource.

17. The UE of claim 16, wherein the processor is further configured to derive the at least one CQI based on a specified CoMP transmission scheme.

18. The UE of claim 17, wherein the specified CoMP transmission scheme comprises Joint Transmission (JT) scheme or Dynamic Point Selection (DPS) scheme.

19. The UE of claim 18, wherein the processor is further configured to derive the at least one CQI based on all Multiple Input Multiple Output (MIMO) channels of all of at least one non-zero-power CSI-RS resource in the case of JT scheme or to derive the at least one CQI for each of at least one non-zero-power CSI-RS resource in the case of DPS scheme.

20. (canceled)

21. The UE of claim 19, wherein the at least one CQI comprises higher layer-configured sub-band CQIs or UE-selected sub-band CQIs or one wideband CQI.

22. The UE of claim 21, wherein the at least one PMI associated with the each of at least one CSI-RS resource comprises one wide-band PMI or at least one sub-band PMI associated with the each of at least one CSI-RS resource or wherein the at least one CQI further comprises a wide-band CQI, and, wherein the higher layer-configured sub-band CQIs, when being transmitted to the network side, are represented by values obtained through encoding, by an encoder of the UE, respective sub-band CQI of the higher layer-configured sub-band CQIs differentially with the wide-band CQI or wherein the transmitter is further configured to transmit the wide-band CQI, the higher layer-configured sub-band CQIs and the PMI associated with the each of at least one CSI-RS resource on a Physical Uplink Shared Channel (PUSCH), in response to a receiver of the UE receiving a trigger from at least one Transmission Point involved in the CoMP transmission.

23. (canceled)

24. (canceled)

25. (canceled)

26. The UE of claim 21, wherein the at least one PMI associated with the each of at least one CSI-RS resource comprises one wide-band PMI associated with the each of at least one CSI-RS resource.

27. The UE of claim 26, wherein the transmitter is further configured to transmit the at least one CQI and the at least one PMI on a plurality of Physical Uplink Control Channel (PUCCH) resources periodically or the plurality of PUCCH resources are allocated in a Time Division Multiplexing (TDM), a Frequency Division Multiplexing (FDM) or a Code Division Multiplexing (CDM).

28. (canceled)

29. The method as set forth in claim 1 implemented on a computer-readable storage medium carrying one or more sequences of one or more instructions.
